(19) United States
(12) Patent Application Publication
(10) Pub. No.: US 2026/0238481 A1
(43) Pub. Date: Aug. 13, 2026

(54) APPARATUS AND METHOD FOR SHARING DATA BASED ON BLOCKCHAIN

(71) Applicant: ELECTRONICS AND TELECOMMUNICATION RESEARCH INSTITUTE, Daejeon (KR)

(72) Inventors: Joon-Young LEE, Daejeon (KR); Myeong-Hyun KIM, Daejeon (KR); Tae-Sung KIM, Daejeon (KR); Sung-Jin YU, Daejeon (KR); Bo-Heung CHUNG, Daejeon (KR); Keon-Woo KIM, Daejeon (KR); You-Sung KANG, Daejeon (KR); Young-Ho PARK, Daegu (KR); Deok-Kyu KWON, Daegu (KR); Ji-Hyeon OH, Gimhae-si (KR)

(73) Assignee: ELECTRONICS AND TELECOMMUNICATION RESEARCH INSTITUTE, Deajeon (KR)

(21) Appl. No.: 19/093,492

(22) Filed: Mar. 28, 2025

(30) Foreign Application Priority Data
Feb. 12, 2025 (KR) 10-2025-0017946

(51) Int. Cl. H04L 9/32; G06F 21/60; H04L 9/00

(52) U.S. Cl. CPC H04L 9/3213; G06F 21/602; H04L 9/50

(57) ABSTRACT

Disclosed herein is an apparatus and method for sharing data based on blockchain. The apparatus receives an aggregate key and an attribute token in response to a data request made by a data user to a data owner, requests a data storage location from a blockchain using a trapdoor generated based on the aggregate key and the attribute token, requests data from a cloud server based on the data storage location, and decrypts the data received from the cloud server.

### CROSS REFERENCE TO RELATED APPLICATION

This application claims the benefit of Korean Patent Application No. 10-2025-0017946, filed Feb. 12, 2025, which is hereby incorporated by reference in its entirety into this application.

### BACKGROUND OF THE INVENTION

### 1. Technical Field

The present disclosure relates generally to blockchain technology, and more particularly to technology for sharing data based on blockchain.

### 2. Description of the Related Art

With the development and implementation of Internet of Things (IoT), IoT is increasingly applied to various environments, such as smart cities, smart factories, smart healthcare, etc., thereby providing convenient services to users. However, information collected by IoT devices may include sensitive personal information, which may cause privacy concerns, and data transmitted over public channels is vulnerable to security threats such as active attacks, key breaches, data breaches, and the like. Various access control technologies have been researched to enhance security of IoT data. However, existing access control technologies, such as role-based access control, key policy attribute-based encryption (KP-ABE), and ciphertext policy attribute-based encryption (CP-ABE), have limited effectiveness depending on access policies or the number of users. Also, the current access control methods mostly involve the intervention of a trusted authority and do not guarantee the information subject's rights of data-sharing service users. As technologies for solving these problems, Key Aggregate Encryption (KAE) and Key Aggregate Searchable Encryption (KASE), which enable data-centric access control, have come into the spotlight. Using KAE and KASE, the code of a data set can be deciphered using only a single key provided by a data owner to a data user who wants to receive data. Accordingly, the data owner may generate a key without the help of a trusted authority, and provision of only a single key may ensure the rights of the information subject and solve the efficiency problem. Also, in the event of an emergency (e.g., when a patient's life is in danger), it may be necessary for a medical staff member who has been granted permission to access the patient's data to delegate the permission to other medical staff members when the medical staff member is absent. Even during the delegation, it should be possible for the patient (data owner) to know who has been entrusted with their data in order to avoid privacy breaches.

Meanwhile, Korean Patent No. 10-2298266, titled “Data access control method and system using attribute-based password for secure and efficient data sharing in cloud environment”, discloses a data access control method and system using attribute-based passwords for secure and efficient data sharing in a cloud environment, in which data may be efficiently shared in a cloud environment by utilizing CP-ABE, which is a type of attribute-based password.

### SUMMARY OF THE INVENTION

An object of the present disclosure is to ensure data integrity for secure permission delegation and to provide a blockchain-based data sharing method for data auditing.

Another object of the present disclosure is to provide a blockchain-based data sharing method without the involvement of a trusted authority.

A further object of the present disclosure is to provide a data encryption solution for the independent data sharing of data owners.

Yet another object of the present disclosure is to drastically reduce social and economic losses caused by hacking by preventing security issues that can occur due to data forgery, man-in-the-middle attacks, and spoofing attacks by hacking.

Still another object of the present disclosure is to enable a data user to delegate permissions to access data of a data owner to another user when the data owner is unable to share the data.

Still another object of the present disclosure is to provide a flexible data-sharing solution by providing a data auditing function.

In order to accomplish the above objects, an apparatus for sharing data based on blockchain according to an embodiment of the present disclosure includes one or more processors and memory for storing at least one program executed by the one or more processors, and the at least one program receives an aggregate key and an attribute token in response to a data request made by a data user to a data owner, requests a data storage location from a blockchain using a trapdoor generated based on the aggregate key and the attribute token, requests data from a cloud server based on the data storage location, and decrypts the data received from the cloud server.

Here, the data owner may encrypt data including an attribute value and a keyword value and store the encrypted data in the cloud server, and the cloud server may record the location where the encrypted data is stored on the blockchain.

Here, the at least one program may transmit a request message, including the generated trapdoor, pseudonymous identification information encrypted with a public key, and a timestamp, to the blockchain.

Here, the blockchain may retrieve data corresponding to the pseudo-identifier included in the request message, verify whether the trapdoor matches the retrieved data, and return the data storage location based on the verification result.

Here, the cloud server may verify authentication information of the data user and check an encrypted storage location of the requested data, and when the data user is authenticated by the cloud server, the cloud server may return a data retrieval result.

Here, the at least one program may verify authentication information for decrypting the data and decrypt the data using an encryption key provided by the cloud server and a secret key of the data user.

Here, the at least one program may store a permission delegation message encrypted using the aggregate key, a secret key, and a public key of an additional data user on the blockchain as a transaction and transmit a permission delegation index, a transaction address, and a distribution identifier to the additional data user, thereby delegating data retrieval permission between the data users.

Here, using the permission delegation index, the transaction address, and the distribution identifier, the additional data user may request permission delegation from the blockchain and obtain the permission delegation message and the aggregate key from the blockchain.

Also, in order to accomplish the above objects, a method for sharing data based on blockchain, performed by an apparatus for sharing data based on blockchain, according to an embodiment of the present disclosure includes receiving an aggregate key and an attribute token in response to a data request made by a data user to a data owner, requesting a data storage location from a blockchain using a trapdoor generated based on the aggregate key and the attribute token, requesting data from a cloud server based on the data storage location, and decrypting the data received from the cloud server.

Here, the method for sharing data based on blockchain may further include, before receiving the aggregate key and the attribute token, encrypting, by the data owner, data including an attribute value and a keyword value, storing, by the data owner, the encrypted data in the cloud server, and recording, by the cloud server, a location where the encrypted data is stored on the blockchain.

Here, requesting the data storage location may comprise transmitting a request message, including the generated trapdoor, pseudonymous identification information encrypted with a public key, and a timestamp, to the blockchain.

Here, requesting the data storage location may comprise retrieving, by the blockchain, data corresponding to the pseudo-identifier included in the request message, verifying, by the blockchain, whether the trapdoor matches the retrieved data, and returning, by the blockchain, the data storage location based on the verification result.

Here, requesting the data may comprise verifying, by the cloud server, authentication information of the data user, checking, by the cloud server, an encrypted storage location of the requested data, and returning, by the cloud server, a data retrieval result when the data user is authenticated by the cloud server.

Here, decrypting the data may comprise verifying authentication information for decrypting the data and decrypting the data using an encryption key provided by the cloud server and a secret key of the data user.

Here, the method for sharing data based on blockchain may further include storing a permission delegation message encrypted using the aggregate key, a secret key, and a public key of an additional data user on the blockchain as a transaction and transmitting a permission delegation index, a transaction address, and a distribution identifier to the additional data user, thereby delegating data retrieval permission between the data users.

Here, delegating the data retrieval permission may comprise requesting, by the additional data user, permission delegation from the blockchain using the permission delegation index, the transaction address, and the distribution identifier and obtaining, by the additional data user, the permission delegation message and the aggregate key from the blockchain.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for sharing data based on blockchain according to an embodiment of the present disclosure;

FIG. 2 is a sequence diagram illustrating the process of a method in which a data owner encrypts and stores data according to an embodiment of the present disclosure;

FIG. 3 is a sequence diagram illustrating the process of generating an aggregate key and an attribute token in response to a data request made by a data user to a data owner according to an embodiment of the present disclosure;

FIG. 4 is a sequence diagram illustrating a process in which a data user requests a data storage location from a blockchain according to an embodiment of the present disclosure;

FIG. 5 is a sequence diagram illustrating a process in which a data user requests data from a cloud server and the cloud server retrieves the data and authenticates the data user according to an embodiment of the present disclosure;

FIG. 6 is a sequence diagram illustrating a process in which a data user authenticates a cloud server and decrypts data according to an embodiment of the present disclosure;

FIG. 7 is a sequence diagram illustrating a process in which data user A delegates part of data retrieval permission to data user B according to an embodiment of the present disclosure; and

FIG. 8 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

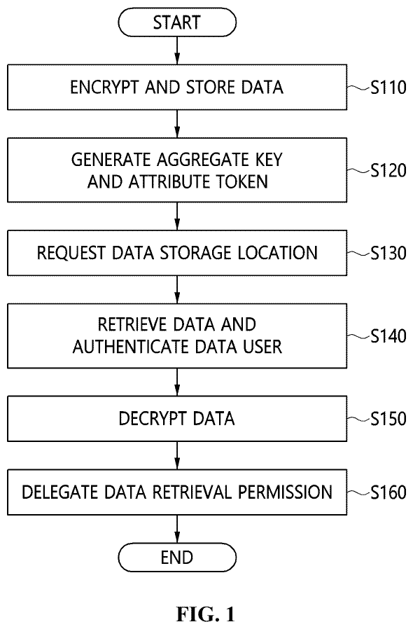

FIG. 1 is a flowchart illustrating a method for sharing data based on blockchain according to an embodiment of the present disclosure.

Referring to FIG. 1, in the method for sharing data based on blockchain according to an embodiment of the present disclosure, first, data may be encrypted and stored at step S110.

That is, at step S110, a data owner 10 may encrypt and store data.

Also, in the method for sharing data based on blockchain according to an embodiment of the present disclosure, an aggregate key and an attribute token may be generated at step S120.

That is, at step S120, a data user 100 may request data from the data owner 10, and an aggregate key and an attribute token may be generated.

Here, the data user 100 may correspond to a user who uses a blockchain-based data sharing apparatus according to an embodiment of the present disclosure.

Also, in the method for sharing data based on blockchain according to an embodiment of the present disclosure, a data storage location may be requested at step S130.

That is, at step S130, the data user 100 may request a data storage location from a blockchain 30.

Also, in the method for sharing data based on blockchain according to an embodiment of the present disclosure, the data may be retrieved, and the data user may be authenticated at step S140.

That is, at step S140, the data user may request the data from a cloud server, and the cloud server may retrieve the data and authenticate the data user.

Also, in the method for sharing data based on blockchain according to an embodiment of the present disclosure, the data may be decrypted at step S150.

That is, at step S150, the cloud server 20 may retrieve the data, and data user 100 may authenticate the cloud server and decrypt the data.

Also, in the method for sharing data based on blockchain according to an embodiment of the present disclosure, data retrieval permission may be delegated at step S160.

That is, at step S160, the data user 100 may delegate part of the data retrieval permission to another data user 200.

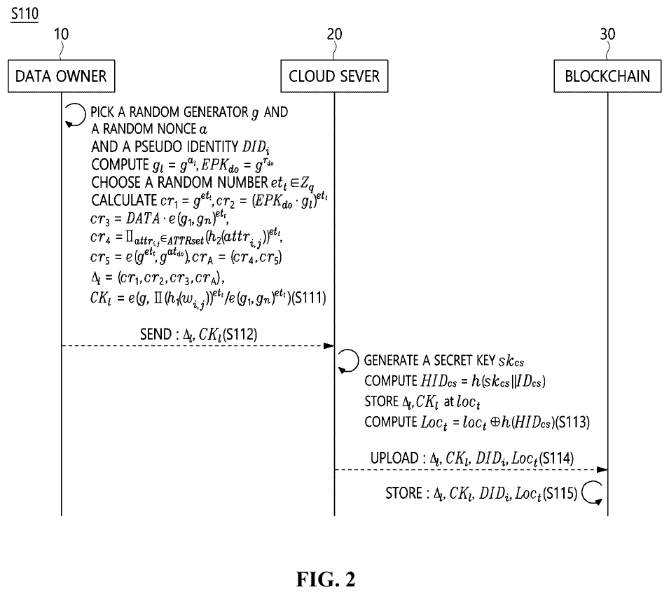

FIG. 2 is a sequence diagram illustrating the process of a method in which a data owner encrypts and stores data according to an embodiment of the present disclosure.

Referring to FIG. 2, it can be seen that an example of the data encryption and storage step (S110) in FIG. 1 is illustrated in detail.

In order to encrypt data, the data owner 10 may generate a random number generator and a random number a and select pseudonymous identification information DIDᵢ. Subsequently, the data owner may calculate gₗ=g^{α}^{ₗ} corresponding to l, which is the number of pieces of data, and calculate a public key EPK_{do} in order to encrypt the data. Subsequently, the data owner selects a random nonce etₜ and encrypts the data along with an attribute value and a keyword value, thereby calculating Δₗ and CKₗ at step S111.

Subsequently, the data owner 10 may transmit the values to the cloud server 20 at step S112.

The cloud server 20 may calculate pseudonymous identification information HID_{cs} using a secret key sk_{cs} and identification information ID_{cs} at step S113.

The cloud server 20 may store Δₗ and CKₗ at locₜ, calculate an encrypted storage location Locₜ, and transmit {Δₗ, CKₗ, DIDᵢ, Locₜ} to the blockchain 30 at step S114.

The blockchain 30 may generate a transaction from {Δₗ, CKₗ, DIDᵢ, Locₜ} and store the same at step S115.

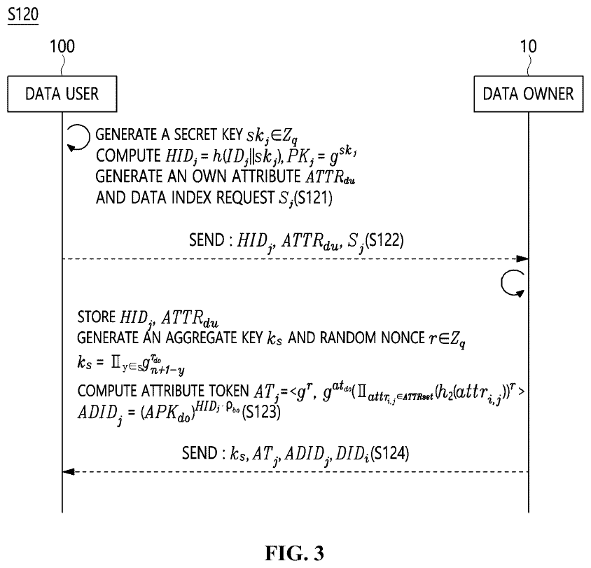

FIG. 3 is a sequence diagram illustrating the process of generating an aggregate key and an attribute token in response to a data request made by a data user to a data owner according to an embodiment of the present disclosure.

Referring to FIG. 3, it can be seen that an example of the aggregate key and attribute token generation step (S120) in FIG. 1 is illustrated in detail.

The data user 100 may calculate a value for requesting desired data from the data owner 10. Before that, the data user 100 may select a secret key skⱼ and calculate pseudonymous identification information HIDⱼ and a public key PKⱼ. In order to request an aggregate key and an attribute token, the data user 100 may select a random nonce r and select ATTR_{du} and Sⱼ, which are the attribute value of the data user and a data request set, respectively, at step S121.

Subsequently, the data user 100 may transmit {HIDⱼ, ATTR_{du}, Sⱼ}, which is a message for requesting an aggregate key and an attribute token, to the data owner 10 at step S122.

The data owner 10 may store HIDⱼ and ATTR_{du} included in the received message in a database. Later, the data owner 10 may identify the data user 100 who retrieves data through a search history log. The data owner 10 may calculate an aggregate key kₛ corresponding to the data index requested by the data user 100 at step S123. Here, n is the total number of pieces of data held by the data owner.

The data owner 10 may calculate an attribute token ATⱼ, calculate pseudonymous identification information ADIDⱼ, which can be used for future authentication, using a public key APK_{do}, and transmit {kₛ, ATⱼ, ADIDⱼ, DIDᵢ} to the data user 100 at step S124.

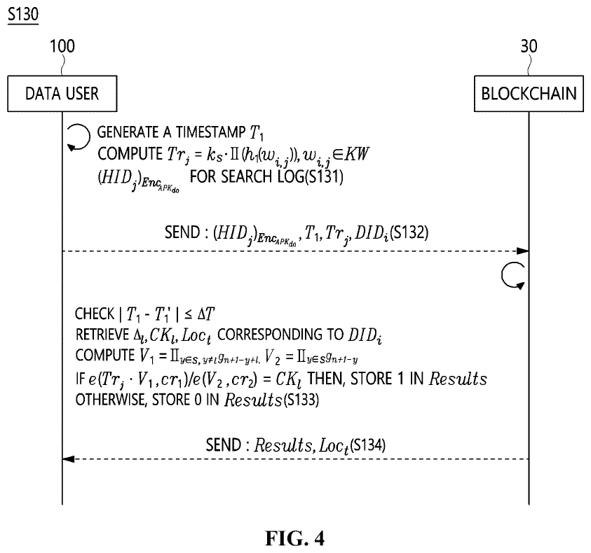

FIG. 4 is a sequence diagram illustrating a process in which a data user requests a data storage location from a blockchain according to an embodiment of the present disclosure.

Referring to FIG. 4, it can be seen that an example of the data storage location request step (S130) in FIG. 1 is illustrated in detail.

In order to retrieve the desired data, the data user 100 may calculate and generate a trapdoor Trⱼ using a keyword set KW and the aggregate key kₛ. The data user 100 may generate a timestamp T₁ and calculate

$${( {HID}_{j} )}_{{Enc}_{{APK}_{do}}}$$

by encrypting the pseudonymous identification information of the data user with APK_{do}, which is the public key of the data owner, in order to store a search history log on the blockchain at step S131.

Subsequently, the data user 100 may transmit

$$\{ {( {HID}_{j} )}_{{Enc}_{{APK}_{do}}} ,$$

T₁, Trⱼ, DIDᵢ} to the blockchain 30 at step S132.

Using the received message, the blockchain 30 may retrieve Δₗ, CKₗ, and Locₜ associated with DIDᵢ and calculate V₁ and V₂. The blockchain 30 may calculate e(Trⱼ·V₁, cr₁)/e(V₂, cr₂) using V₁ and V₂ and then verify whether the result is equal to CKₗ. If the two values are equal to each other, the blockchain 30 may store 1 in Results set, but if not, the blockchain 30 may store 0 in Results set at step S133. That is, 1 indicates that the data owner actually has the index requested by the data user 100, and 0 indicates that the data owner does not have the index.

The blockchain 30 may transmit a retrieval result message {Results, Locₜ} to the data user at step S134.

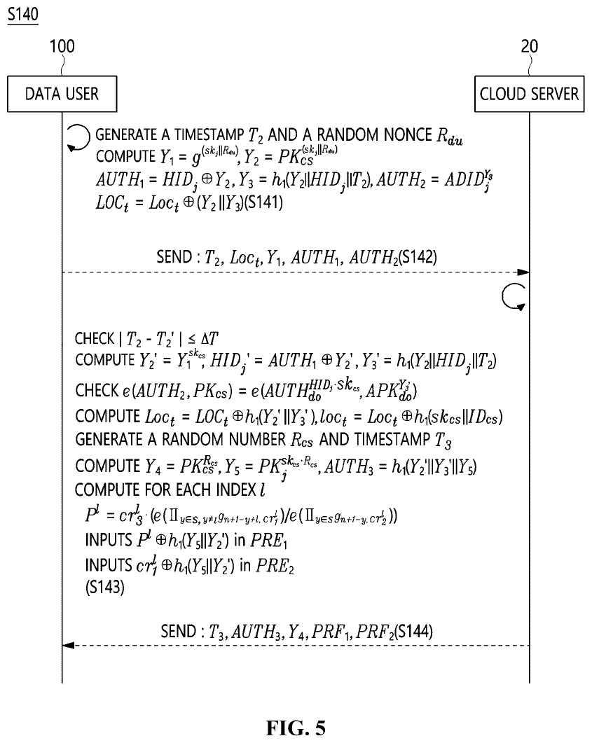

FIG. 5 is a sequence diagram illustrating a process in which a data user requests data from a cloud server and the cloud server retrieves the data and authenticates the data user according to an embodiment of the present disclosure.

Referring to FIG. 5, it can be seen that an example of the data retrieval and data user authentication step (S140) in FIG. 1 is illustrated in detail.

The data user 100 may generate a timestamp T₂ and a random nonce R_{du} and calculate parameters for requesting data and authentication from the cloud server 20 at step S141.

Subsequently, the data user 100 may transmit a data request message {T₂, LOCₜ, Y₁, AUTH₁, AUTH₂} to the cloud server 20 at step S142.

The cloud server 20 checks whether the timestamp is valid, and if the timestamp is a valid value, the cloud server 20 may calculate Y₂′, Y₃′, and HIDⱼ′. Subsequently, the cloud server 20 may verify whether the value of e(AUTH₂, PK_{cs}) matches the value of

$$e ( {APK}_{do}^{{HID}_{j} \cdot {sk}_{cs}} , {APK}_{do}^{{Y}_{3}^{′}} ) .$$

If the verification result is correct, the cloud server 20 may verify and authenticate that the data user 100 is a valid data user. The cloud server 20 may calculate locₜ in order to identify the location of encrypted data and may generate a random nonce R_{cs} and a timestamp T₃. Subsequently, the cloud server 20 may calculate Y₄, Y₅, and AUTH₃ for a credential value using the public key thereof and the public key of the data user 100. Subsequently, P^{l}, which is a value with which the data user 100 may decrypt data, is calculated using values stored at locₜ according to l, which is each index requested by the data user 100, and the value of P^{l}⊕h₁((Y₅∥Y₂′) and the value of

$${cr}_{1}^{l}$$

⊕h₁(Y₅∥Y₂′) may be stored in PRF₁ and PRF₂, respectively, at step S143.

Subsequently, the cloud server 20 may transmit a request response message {T₃, AUTH₃, Y₄, PRF₁, PRF₂} to the data user 100 at step S144.

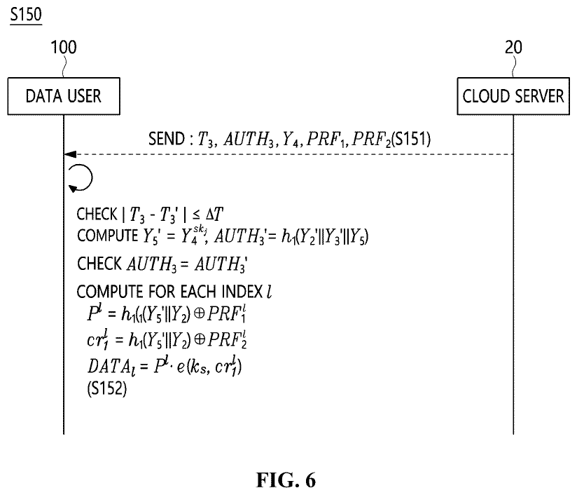

FIG. 6 is a sequence diagram illustrating a process in which a data user authenticates a cloud server and decrypts data according to an embodiment of the present disclosure.

Referring to FIG. 6, it can be seen that an example of the data decryption step (S150) in FIG. 1 is illustrated in detail.

The data user 100 may verify whether the timestamp value is valid after receiving the request response message from the cloud server 20 at step S151.

If the timestamp is a valid value, the data user 100 may calculate the value of Y₅′ and the value of AUTH₃′ in order to verify whether the message is transmitted by a valid cloud server 20. Through this process, the data user 100 may compare the value of AUTH₃′ with the value of AUTH₃ transmitted by the cloud server 20. If the received value is determined to be a correct value as the result of the comparison, the data user 100 may verify and authenticate that the cloud server 20 is a legitimate entity. Subsequently, the data user may calculate P^{l} and

$${cr}_{1}^{l}$$

using the values stored in PRF₁ and PRF₂ according to each data index l. The data user 100 may acquire the original data DATAₗ using P^{l} and

$${cr}_{1}^{l}$$

at step S152.

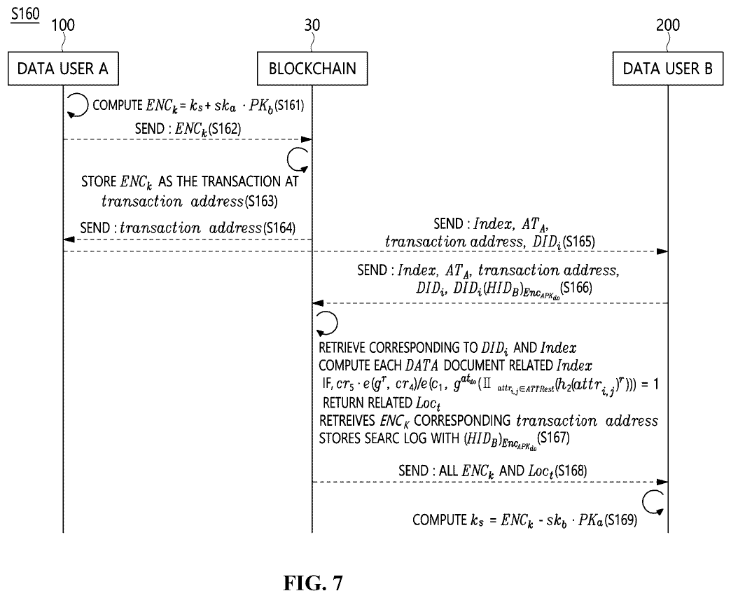

FIG. 7 is a sequence diagram illustrating a process in which data user A delegates part of data retrieval permission to data user B according to an embodiment of the present disclosure.

Referring to FIG. 7, it can be seen that an example of the data retrieval permission delegation step (S160) in FIG. 1 is illustrated in detail.

Data user A 100 may calculate ENCₖ using the aggregate key and secret key held by data user A and the public key of data user B at step S161.

Subsequently, data user A 100 may transmit ENCₖ to the blockchain 30 at step S162.

The blockchain 30 may store ENCₖ as a transaction and specify the location at which ENCₖ is stored as transaction address at step S163.

Subsequently, the blockchain 30 may transmit transaction address to data user A 100 at step S164.

Data user A 100 may store part of the data indexes that can be retrieved by data user A in Index and may transmit {Index, AT_{A}, transaction address, DIDᵢ} to data user B 200 at step S165.

For a search history log, data user B 200 may calculate

$${( {HID}_{B} )}_{{Enc}_{{APK}_{do}}}$$

by encrypting the pseudonymous identification information of data user B with the public key of the data owner, APK_{do}.

Subsequently, data user B may transmit a request message {Index, AT_{A}, transaction address, DIDᵢ,

$${( {HID}_{B} )}_{{Enc}_{{APK}_{do}}} \}$$

to the blockchain 30 in order to obtain the aggregate key at step S166.

After loading data associated with DIDᵢ and Index, the blockchain 30 may calculate crₛ·e(g^{r},cr₄)/e(c₁,g^{at}^{_{do}}(Πₐₜₜᵣ_{_{i,j}}_{∈ATTRset}(h₂(attr_{i,j})^{r}))) for each Index. If the calculated value is 1, the associated Locₜ value may be returned. Subsequently, the blockchain 30 may load ENCₖ stored at transaction address and store the search history log with

$${( {HID}_{B} )}_{{Enc}_{{APK}_{do}}}$$

at step S167.

Finally, the blockchain 30 may transmit all Locₜ values and ENCₖ to data user B 200 as a response message at step S168.

Data user B 200 may obtain the original aggregate key kₛ using the secret key of data user B and the public key of data user A 100 at step S169. Subsequently, data user B 200 may obtain the original data through the processes of FIGS. 4, 5, and 6.

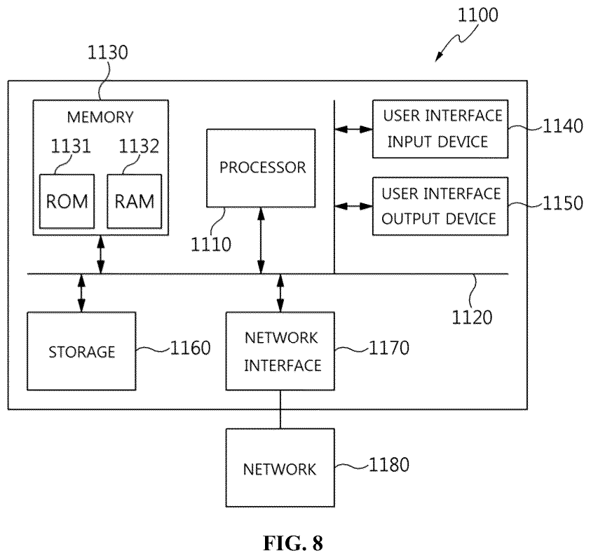

FIG. 8 is a view illustrating a computer system according to an embodiment of the present disclosure.

Referring to FIG. 8, the apparatus 100 for sharing data based on blockchain according to an embodiment of the present disclosure may be implemented in a computer system 1100 including a computer-readable recording medium. As illustrated in FIG. 8, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus 100 for sharing data based on blockchain according to an embodiment of the present disclosure includes one or more processors 1110 and memory 1130 for storing at least one program executed by the one or more processors 1110, and the at least one program receives an aggregate key and an attribute token in response to a data request made by a data user to a data owner, requests a data storage location from a blockchain using a trapdoor generated based on the aggregate key and the attribute token, requests data from a cloud server based on the data storage location, and decrypts the data received from the cloud server.

Here, the data owner may encrypt data including an attribute value and a keyword value and store the encrypted data in the cloud server, and the cloud server may record the location where the encrypted data is stored on the blockchain.

Here, the at least one program may transmit a request message, including the generated trapdoor, pseudonymous identification information encrypted with a public key, and a timestamp, to the blockchain.

Here, the blockchain may retrieve data corresponding to the pseudo-identifier included in the request message, verify whether the trapdoor matches the retrieved data, and return the data storage location based on the verification result.

Here, the cloud server may verify the authentication information of the data user and check the encrypted storage location of the requested data, and when the data user is authenticated by the cloud server, the cloud server may return the data retrieval result.

Here, the at least one program may verify authentication information for decrypting the data and decrypt the data using an encryption key provided by the cloud server and the secret key of the data user.

Here, the at least one program stores a permission delegation message encrypted using the aggregate key, a secret key, and the public key of an additional data user on the blockchain as a transaction and transmits a permission delegation index, a transaction address, and a distribution identifier to the additional data user, thereby delegating the data retrieval permission between the data users.

Here, the additional data user may request permission delegation from the blockchain using the permission delegation index, the transaction address, and the distribution identifier and obtain the permission delegation message and the aggregate key from the blockchain.

The present disclosure may ensure data integrity for secure permission delegation and provide a blockchain-based data sharing method for data auditing.

Also, the present disclosure may provide a blockchain-based data sharing method without the involvement of a trusted authority.

Also, the present disclosure may provide a data encryption solution for the independent data sharing of data owners.

Also, the present disclosure may drastically reduce social and economic losses caused by hacking by preventing security issues that can occur due to data forgery, man-in-the-middle attacks, and spoofing attacks by hacking.

Also, the present disclosure may enable a data user to delegate permission to access data of a data owner to another user when the data owner is unable to share the data.

Also, the present disclosure may provide a flexible data-sharing solution by providing a data auditing function.

As described above, the apparatus and method for sharing data based on blockchain according to the present disclosure are not limitedly applied to the configurations and operations of the above-described embodiments, but all or some of the embodiments may be selectively combined and configured, so the embodiments may be modified in various ways.

What is claimed is:

1. An apparatus for sharing data based on blockchain, comprising:
one or more processors; and
memory for storing at least one program executed by the one or more processors,
wherein the at least one program
receives an aggregate key and an attribute token in response to a data request made by a data user to a data owner,
requests a data storage location from a blockchain using a trapdoor generated based on the aggregate key and the attribute token,
requests data from a cloud server based on the data storage location, and
decrypts the data received from the cloud server.

2. The apparatus of claim 1, wherein
the data owner encrypts data including an attribute value and a keyword value and stores the encrypted data in the cloud server, and
the cloud server records a location where the encrypted data is stored on the blockchain.

3. The apparatus of claim 1, wherein the at least one program transmits a request message, including the generated trapdoor, pseudonymous identification information encrypted with a public key, and a timestamp, to the blockchain.

4. The apparatus of claim 3, wherein the blockchain retrieves data corresponding to the pseudo-identifier included in the request message, verifies whether the trapdoor matches the retrieved data, and returns the data storage location based on the verification result.

5. The apparatus of claim 1, wherein
the cloud server verifies authentication information of the data user and checks an encrypted storage location of the requested data, and
when the data user is authenticated by the cloud server, the cloud server returns a data retrieval result.

6. The apparatus of claim 1, wherein the at least one program verifies authentication information for decrypting the data and decrypts the data using an encryption key provided by the cloud server and a secret key of the data user.

7. The apparatus of claim 1, wherein the at least one program stores a permission delegation message encrypted using the aggregate key, a secret key, and a public key of an additional data user on the blockchain as a transaction and transmits a permission delegation index, a transaction address, and a distribution identifier to the additional data user, thereby delegating data retrieval permission between the data users.

8. The apparatus of claim 7, wherein the additional data user requests permission delegation from the blockchain using the permission delegation index, the transaction address, and the distribution identifier and obtains the permission delegation message and the aggregate key from the blockchain.

9. A method for sharing data based on blockchain, performed by an apparatus for sharing data based on blockchain, comprising:
receiving an aggregate key and an attribute token in response to a data request made by a data user to a data owner;
requesting a data storage location from a blockchain using a trapdoor generated based on the aggregate key and the attribute token;
requesting data from a cloud server based on the data storage location; and
decrypting the data received from the cloud server.

10. The method of claim 9, further comprising:
before receiving the aggregate key and the attribute token,
encrypting, by the data owner, data including an attribute value and a keyword value,
storing, by the data owner, the encrypted data in the cloud server, and
recording, by the cloud server, a location where the encrypted data is stored on the blockchain.

11. The method of claim 9, wherein requesting the data storage location comprises transmitting a request message, including the generated trapdoor, pseudonymous identification information encrypted with a public key, and a timestamp, to the blockchain.

12. The method of claim 11, wherein requesting the data storage location comprises retrieving, by the blockchain, data corresponding to the pseudo-identifier included in the request message, verifying, by the blockchain, whether the trapdoor matches the retrieved data, and returning, by the blockchain, the data storage location based on the verification result.

13. The method of claim 9, wherein requesting the data comprises verifying, by the cloud server, authentication information of the data user, checking, by the cloud server, an encrypted storage location of the requested data, and returning, by the cloud server, a data retrieval result when the data user is authenticated by the cloud server.

14. The method of claim 9, wherein decrypting the data comprises verifying authentication information for decrypting the data and decrypting the data using an encryption key provided by the cloud server and a secret key of the data user.

15. The method of claim 9, further comprising:
storing a permission delegation message encrypted using the aggregate key, a secret key, and a public key of an additional data user on the blockchain as a transaction and transmitting a permission delegation index, a transaction address, and a distribution identifier to the additional data user, thereby delegating data retrieval permission between the data users.

16. The method of claim 15, wherein delegating the data retrieval permission comprises requesting, by the additional data user, permission delegation from the blockchain using the permission delegation index, the transaction address, and the distribution identifier and obtaining, by the additional data user, the permission delegation message and the aggregate key from the blockchain.
